(19) United States
(12) Patent Application Publication
(10) Pub. No.: US 2006/0175163 A1
(43) Pub. Date: Aug. 10, 2006

(54) Method and arrangement for parking braking at a disc brake

(76) Inventor: Lars Severinsson, Hishult (SE)

Correspondence Address: ST. ONGE STEWARD JOHNSTON & REENS, LLC, 986 BEDFORD STREET, STAMFORD, CT, 06905-5619, US

(21) Appl. No.: 11/374,498

(22) Filed: Mar. 13, 2006

Related U.S. Application Data
(63) Continuation of application No. PCT/SE04/01380, filed on Sep. 24, 2004.

(30) Foreign Application Priority Data
Sep. 26, 2003 (SE) 0302563-2

(51) Int. Cl. F16D 55/46

(52) U.S. Cl. 188/265; 188/72.2; 188/72.7; 188/162

(57) ABSTRACT

A self-energizing disc brake has an assembly including a brake pad, movable by service brake actuating means towards and away from a brake disc for service braking. Means are provided for enhancing the application of the brake pad against the brake disc after said assembly has been transferred to engagement with the brake disc and under the action of the rotating brake disc. A parking brake arrangement for this disc brake comprises spring means actuating said assembly for parking braking at will.

### CROSS-REFERENCE TO RELATED APPLICATIONS

This application is a continuation of international patent application PCT/SE2004/001380 filed on Sep. 24, 2004 which designates the United States and claims priority from Swedish patent application SE 0302563-2 filed on Sep. 26, 2003, the content of which is incorporated herein by reference.

### FIELD OF THE INVENTION

The present invention relates to a method and arrangement for parking braking at a self-energizing disc brake, having an assembly including a brake pad, movable by service brake actuating means towards and away from a brake disc for service braking, means being provided for enhancing the application of the brake pad against the brake disc after said assembly has been transferred to engagement with the brake disc and under the action of the rotating brake disc.

### BACKGROUND OF THE INVENTION

A self-energizing disc brake is shown in WO 03/071150. Such a brake requires a parking brake function, which is not covered in the above publication. Such a parking brake function, also involving a safety function, needs to be reliable and shall be as simple—and thus cheap—as possible. The invention also relates to fail-safe and fail tolerant arrangements of other electromechanical brakes.

### SUMMARY OF THE INVENTION

The above objects are fulfilled in that in a method according to the invention a spring force is applied to the assembly for accomplishing parking braking at will, the spring force being generally axially or tangentially applied.

A parking brake arrangement according to the invention has spring means actuating said assembly for parking braking at will.

As appears from the above mentioned publication, the service brake actuating means is in the practical case controlled by an electric motor for submitting a rotary motion to an outgoing drive shaft. For accomplishing the parking brake function in this case, a clock spring or spiral spring may be arranged in the movement transmitting chain between the motor and the shaft. The spring is prestressed in a direction for applying the brake.

As shown in the mentioned publication, a transmission unit for rotary speed reduction is arranged between the electric motor and the drive shaft.

This transmission unit is in the practical case a planetary gear assembly with a sun wheel driven by the motor, planet wheels in gear engagement with the sun wheel and an outer, circumferential gear ring, with which the planet wheels are in gear engagement, each planet wheel having a central pin for transferring rotary motion to the drive shaft at its rotation around the sun wheel.

Here, the clock spring is arranged to act in a brake applying direction on a planet holder, which is rotatably journalled in a housing of the motor and is provided with the pins, on which the planet wheels are journalled.

In most embodiments of the parking brake arrangement, the gear ring is fixed in the housing.

The spring may then be attached to the housing and the planet holder with its two ends.

In a basic ambodiment the spring is attached to the housing at its outer end and to a spring sleeve at its inner end, the spring sleeve being connectable at will to the planet holder by means of a drive pin engageable with a drive edge of the planet holder for driving the planet holder in a brake applying direction.

In this case the spring sleeve may be provided with a releasable locking device, which may be an electromagnetic locking device acting on the spring sleeve via gears. The locking device may be combined with an electric parking brake motor.

In another embodiment, the spring is attached to a housing sleeve and the planet holder with its two ends.

The spring may here preferably be attached to the housing sleeve at its outer end and to a spring sleeve at its inner end, the spring sleeve being connectable at will to the planet holder by means of a drive pin engageable with a drive edge of the planet holder for driving the planet holder in a brake applying direction and with the housing sleeve by means of a transmission pin engageable with a drive edge of the planet holder for driving the planet holder in a brake applying direction.

In still another embodiment, the spring is attached to the housing sleeve at its outer end and to a spring sleeve at its inner end, the spring sleeve being connectable at will to the planet holder by means of a drive pin engageable with a drive edge of the planet holder for driving the planet holder in a brake applying direction and the housing sleeve being connectable at will to a planet holder flange by means of a drive pin engageable with a drive edge of the planet holder flange for driving the planet holder in a brake releasing direction.

### BRIEF DESCRIPTION OF THE DRAWINGS

The invention will be described in more detail below under reference to the accompanying drawings, in which embodiments are somewhat schematically illustrated and in which

FIG. 1 is a side-view of a self-energizing disc brake to be equipped with a parking brake according to the invention,

FIGS. 2A and 2B are very schematical illustrations of the principle of the parking brake according to the invention,

FIG. 3, partly sectional, illustrates a self-energizing disc brake with service brake actuating means and with a first embodiment of a parking brake according to the invention,

FIG. 4 illustrates a second embodiment of an inventive parking brake,

FIG. 5 illustrates a third embodiment of an inventive parking brake,

FIG. 6 is a view along the line VI-VI in FIG. 5,

FIG. 7 illustrates a fourth embodiment of an inventive parking brake,

FIG. 8 is a view along the line VIII-VIII in FIG. 7,

FIG. 9 illustrates a fifth embodiment of an inventive parking brake,

FIG. 10 is a view along the line X-X in FIGS. 9 and 12,

FIG. 11 is a view along the line XI-XI in FIGS. 9 and 12,

FIG. 12 illustrates a sixth embodiment of an inventive parking brake,

FIG. 13 illustrates a seventh embodiment of an inventive parking brake,

FIG. 14 is a view along the line XIV-XIV in FIG. 13,

FIG. 15 illustrates an eighth embodiment of an inventive parking brake,

FIG. 16 illustrates a ninth embodiment of an inventive parking brake,

FIG. 17 illustrates a tenth embodiment of an inventive parking brake,

FIG. 18 illustrates an eleventh embodiment of an inventive parking brake,

FIG. 19 is a view along the line IXX-IXX in FIG. 18,

FIG. 20 is a view along the line XX-XX in FIG. 18,

FIG. 21 illustrates the principles of the embodiment of FIG. 17, adapted to a linear actuation principle,

FIG. 22 illustrates the principles of the embodiments of FIGS. 5 and 7, adapted to a linear actuation principle,

FIG. 23 illustrates a twelfth embodiment of an inventive parking brake, and

FIG. 24 illustrates a thirteenth embodiment of an inventive parking brake.

### DETAILED DESCRIPTION OF THE INVENTION

For a brake application, a control force which is substantially transverse to the brake disc 1 (or in other words substantially axial) is applied on the ramp plate 2 in a way to be described, until contact between the brake pad 3 and the disc 1 is established. By means of the friction force, the ramp plate 2 is transferred in the rotation direction of the disc 1, so that the rollers 5 roll up the relevant ramps 2′ and 4′ and an application force is accomplished without applying any external brake force besides the control force. In other words the brake has a self-servo effect or is self-energizing.

The application force may be controlled by the control force, which may be positive or negative, ie acting in a brake applying or brake releasing direction.

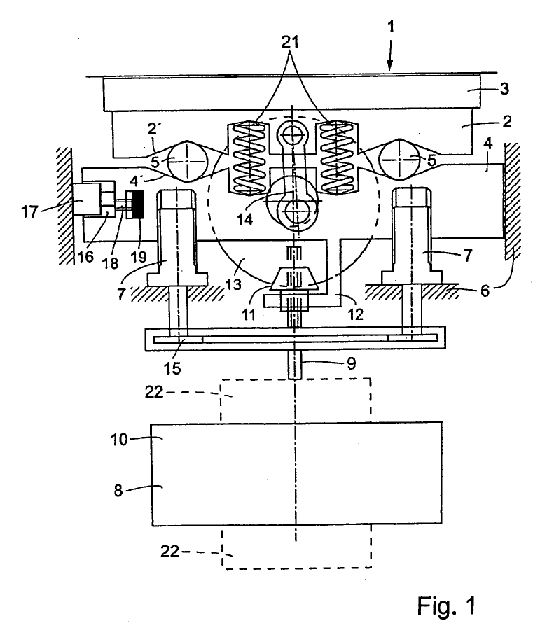

The disc brake shown in FIG. 1 is arranged in a disc brake caliper 6 in a way well known in the art. The caliper 6, which is placed astraddle of the brake disc 1, is only very schematically illustrated by shaded areas indicating attachment or support portions.

The ramp bridge 4 is connected to the caliper 6 by means of two adjustment screws 7 in two threaded bores in the ramp bridge 4.

Although it is not shown in FIG. 1, it may be advantageous for obtaining full control and a completely synchronous movement of the rollers 5 to provide a common roller cage for them.

The mechanism for creating the control force for service braking is now to be described.

An electric motor 8 can rotate a drive shaft 9 in either direction over a transmission unit 10. A bevel gear 11 supported by an arm 12 from the ramp bridge 4 can be rotated by the shaft 9 but is axially movable thereon by a splines engagement. The bevel gear 11 is in driving engagement with a bevel gear disc 13 rotationally supported by the ramp bridge 4. Eccentrically connected to the bevel gear disc 13 is a crank rod 14, which at its other end is rotationally connected to the ramp plate 2.

By turning the bevel gear disc 13 in either direction by means of the bevel gear 11 from the motor 8, the position of the ramp plate 2 in relation to the ramp bridge 4 can be set. The control force is transmitted by the crank rod 14. When a friction engagement between the brake pad 3 and the brake disc 1 has been established, an application force amplification will be accomplished by the rollers 5 climbing its ramps 2′ and 4′ in response to the tangential movement of the ramp plate 2 caused by the friction engagement with the brake disc 1. The application force may be accurately controlled by rotating the motor 8 in either direction.

The adjustment screws 7 have the purpose of adjusting the position of the ramp bridge 4 in relation to the wear of the brake pad 3 (and the corresponding brake pad on the opposite side of the brake disc 1). The synchronous rotation of the adjustment screws 7 is performed by suitable transmission means, such as a chain 15, driven from the motor shaft 9 in a way not further described.

In a disc brake with self-servo effect of the kind described it is of great importance to incorporate a control system for governing the rotation of the motor 8 for obtaining the desired brake function. An important parameter for this control function is the actual tangential brake force obtained. In the present case this parameter may be assessed in the following way.

A force sensing means of any suitable kind is arranged between the only indicated caliper 6 and the ramp bridge 4. Such a force sensing means can transmit signals indicative of the tangential brake force.

For example, a pressure-transmitting medium 16, preferably rubber, is arranged in a bore in the transverse end of the ramp bridge 4 and is acted on by a plunger 17 in contact with the caliper 6. A push rod 18 is in contact with the medium 16 at one of its ends and with a sensor element 19 at its other end. Signals indicative for the force applied by the push rod 18 and thus the pressure in the medium 16 can be transmitted from the sensor element 19 to the control system of the brake.

A similar force sensing means may also be arranged at the other end of the ramp bridge 4 for providing force signals at a rotation in the opposite direction of the brake disc 1 or in other words at reverse driving of the vehicle on which the brake arrangement is mounted. A further advantage with this is that the brake disc may be mounted at the left or right hand side of the vehicle.

The description so far is for a self-energizing brake for which a parking brake according to the invention as adapted. It has to be noted, that the design of the service brake actuating means and the brake itself does not form any part of the invention and that substantial deviations in this respect are possible.

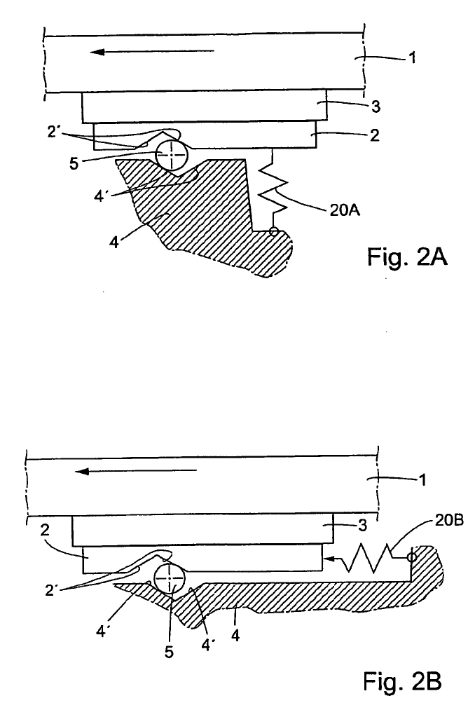

The principle of a parking brake according to the invention is schematically illustrated in FIGS. 2A and 2B, in which the following members of the above described brake can be identified: the brake disc 1, the ramp plate 2, the brake pad 3, the ramp bridge 4, and the roller 5 in ramps 2′ and 4′.

In FIG. 2A, an elastic force acting substantially perpendicularly to or axially on the ramp plate 2 from the ramp bridge 4 is illustrated by a compression spring 20A. This spring 20A will accomplish a parking brake effect. With this elastic force acting on the ramp plate 2, the brake pad 3 will be held applied against the brake disc 1. If the brake disc 1 moves a distance—even a small distance—in the direction of the arrow in FIG. 2, the roller 5 will roll up the ramps 2′ and 4′ as shown and create an application force—a parking brake force.

FIG. 2B is an illustration of the alternative possibility to apply the elastic force substantially tangential or in the direction of the brake disc 1. A compression spring 20B is here arranged between the ramp bridge 4 and the ramp plate 2. The elastic force therefrom will bias the ramp plate 2 to the left in FIG. 2B, so that the roller 5 will roll up the ramps 2′ and 4′, as shown, and apply the brake pad 3 against the brake disc 1. Any rotation of the brake disc 1 in the direction of the arrow will enhance the parking brake force obtained.

The force of the spring 20A or 20B is only relevant in so far as the brake pad 3 is applied to the brake disc 1 with enough force for it to move together with the disc for obtaining the result indicated in FIG. 2A or 2B.

All practical embodiments of a parking brake according to the invention to be shown and described are based on the principle of FIG. 2A with a substantially axial elastic parking brake force. Several embodiments of the principle shown in FIG. 2B could equally well have been shown and described.

In FIG. 1, which is only meant to illustrate the principles of the invention, there are two compression springs 21 between the ramp plate 2 and the ramp bridge 4. In conjunction with the electric motor 8 and the transmission unit 10 there is also a brake control mechanism 22 in either of the two positions indicated by the dashed lines, namely in front of or behind the motor 8 and the transmission unit 10.

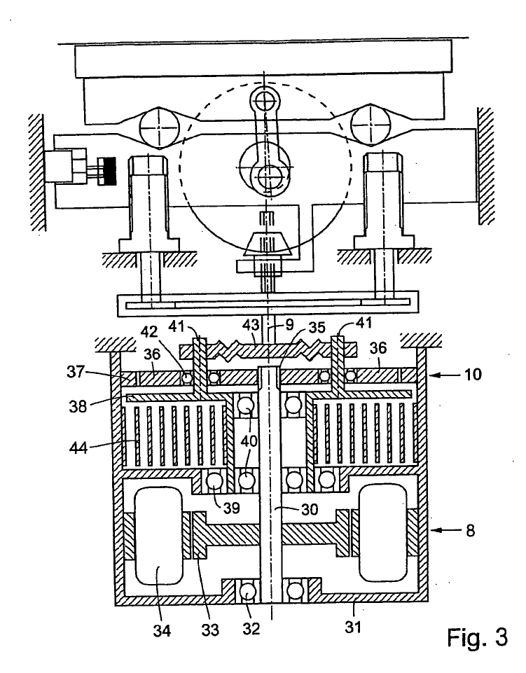

A first practical embodiment of a parking brake according to the invention is shown in FIG. 3. With the exception of the compression springs 21 (which are deleted in the FIG. 3 embodiment and replaced by another spring, as will appear), all major components of the brake itself, shown in FIG. 1, are also shown in FIG. 3 (but in most cases without reference numerals for the sake of clarity). This includes the electric motor 8 and the transmission unit 10, the latter being in effect a planetary gear box for rotational speed reduction.

The electric motor 8 comprises a motor shaft 30, which is journalled with its end in a housing 31 by a bearing 32 and has a rotor 33 for cooperation with a stator 34 in the housing 31. By properly energizing the stator 34, the rotor 33 with the motor shaft 30 will be rotated in the desired direction.

The transmission unit 10 in the same housing 31 is basically a planetary gear box. The motor shaft 30 forms a sun wheel 35, with which for example two planet wheels 36 are in gear engagement. The planet wheels 36 are also in engagement with a circumferential gear ring 37 in the housing 31. A planet holder 38 is rotationally journalled in the housing 31 by means of a bearing 39, and the shaft 30 is journalled in the planet holder 38 by means of bearings 40.

The planet holder 38 has planet holder pins 41, on which the planet wheel 36 are journalled by bearings 42. The planet holder pins 41 are connected by means of a disc 43 with a certain elasticity for allowing a certain freedom. The disc 43 is connected to the drive shaft 9 (see also FIG. 1), which operates the brake or in other words applies a force on the ramp plate 2 in either direction for application or release of the brake.

The first embodiment of the inventive parking brake contains, as is shown in FIG. 3, a prestressed clock spring or spiral spring 44 arranged between and attached to the housing 31 with its outer end and the planet holder 38 with its inner end. The spring 44 is prestressed in the direction for applying the brake, ie it biasses the planet holder 38 in the rotational direction for moving the ramp plate 2 in the direction against the brake disc 1 from the ramp bridge 4.

When the electric motor 8 is de-energized, the self-energizing brake will be applied under the influence of the spring 44. When the electric motor 8 is again energized and rotates in the direction for releasing the brake, the spring 44 will become more prestressed (from the less prestressed condition resulting from the parking brake application).

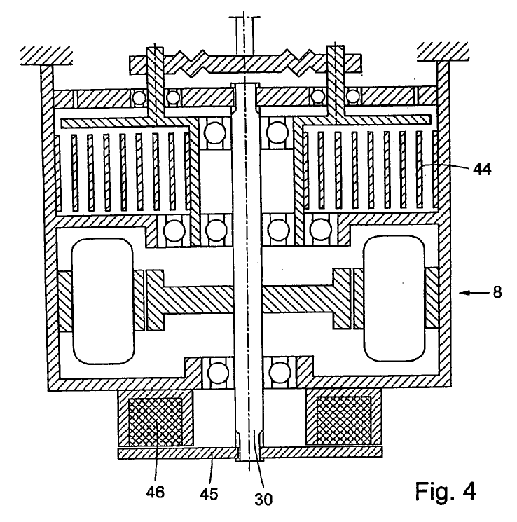

The second embodiment according to FIG. 4 corresponds to the one according to FIG. 3 in all respects except one (to be dealt with below), and for the sake of clarity FIG. 4 is only provided with reference numerals to the extent necessary for illustrating the difference.

As was described above, the electric motor 8 in the first embodiment of FIG. 3 has to be energized at all times, when parking braking is not desired. In order to avoid this necessity, the electric motor is provided with an electromagnetic locking device in the embodiment of FIG. 4. The motor shaft 30 is here provided with a disc 45 and the motor housing 31 has an electromagnetic coil 46 for cooperation with the disc 45. When the coil 46 is energized, the motor 8 will be kept stationary in spite of the bias from the spring 44, and the parking brake is not applied.

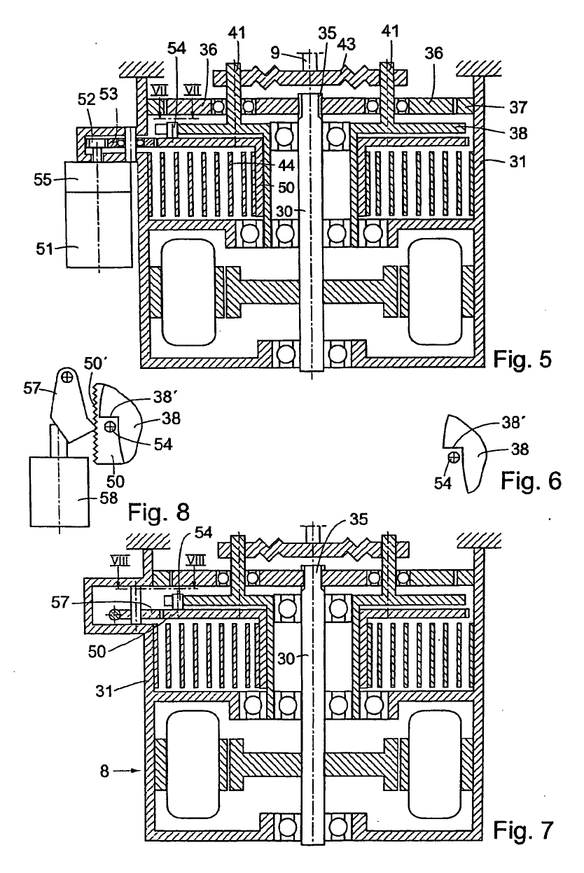

A third and somewhat more sophisticated embodiment is shown in FIGS. 5 and 6. The basic difference in relation to the two previous embodiments of FIGS. 3 and 4 is that in this third embodiment the prestressed parking brake spring is separately controlled by an electrical parking brake motor, which means that the electrical service brake motor is only used as such, even if the functions can be combined into a unit.

In FIG. 5 the same reference numerals are used for corresponding components as in FIG. 3, even if they may be slightly different.

The service brake actuating means or operating mechanism has the same construction in FIG. 5 as in FIG. 3, namely an electrical service brake motor 8 and a transmission unit 10, comprising as main elements the motor shaft 30, the sun wheel 35, the planet wheels 36, the gear ring 37, the planet holder 38, the planet holder pins 41, and the disc 43 connected to the drive shaft 9. The function of the service brake operating mechanism is the same as has been described with reference to FIG. 3.

A separate spring sleeve 50 is rotationally arranged in the planet holder 38. The clock spring or spiral spring 44 is arranged in the spring sleeve 50 with its inner end attached thereto and its outer end attached to the housing 31.

The spring sleeve 50 is rotatable by means of an electric parking brake motor 51 attached to the housing 31. An outgoing gear 52 thereon may be in engagement with an intermediate gear 53, journalled in the housing 31, the intermediate gear 53 in turn being in engagement with an external gear ring on the spring sleeve 50.

The spring sleeve 50 is provided with a drive pin 54 for engaging a drive edge 38′ in the circumference of the planet holder 38, as is also shown in FIG. 6.

Parking braking is obtained when the spring 44 is allowed to rotate the spring sleeve 50 in a brake applying direction and transmit its force via the drive pin 54 to the planet holder 38. This will occur (independently of the service brake operation), if the parking brake motor 51 is rotated in the direction for parking braking or if the motor 51 is not energized. The parking brake is released by rotating the motor 51 in the opposite direction for again prestressing the spring 44.

As in the FIG. 4 embodiment—and for the same purpose—an electromagnetic locking device 55 may be provided, but in this case for the parking brake motor 51.

A fourth embodiment is shown in FIGS. 7 and 8. Basically, it may be seen as a variation of the third embodiment according to FIG. 5. For a description of its service brake operating mechanism, reference is made to the description above of FIG. 5.

Again the parking brake spring 44 is arranged in a spring sleeve 50. The spring sleeve 50 has a drive pin 54 (see also FIG. 8) for engaging a drive edge 38′ in the planet holder 38.

A pawl 57 is pivotally connected to the housing 31 and may be brought into locking engagement with detents 50′ on the circumference of the spring sleeve 50 by means of an electromagnet 58 attached to the housing 31. Alternative locking means are feasible.

The service brake motor 8 will apply and release the brake at rotation in either direction. The parking brake spring 44 biasses the brake into an applied condition when the electromagnetic locking device 50′, 57, 58 is de-energized.

After a parking brake application the spring 44 is rewound or prestressed by rotating the service motor 8 in the release direction and is locked in the prestressed condition by energizing the electromagnetic locking device 50′, 57, 58. This is true also for the embodiment of FIG. 5.

The third embodiment according to FIG. 5 and the fourth embodiment according to FIG. 7 may be combined in a modified embodiment, in which the parking brake motor 51 in FIG. 5 is deleted and only the electromagnetic locking device 55 is retained. The service brake motor 8 will provide the same function as in the fourth embodiment according to FIG. 7.

FIGS. 9-11 show a fifth embodiment, where again its service brake operating mechanism is the same as in the FIG. 3 embodiment.

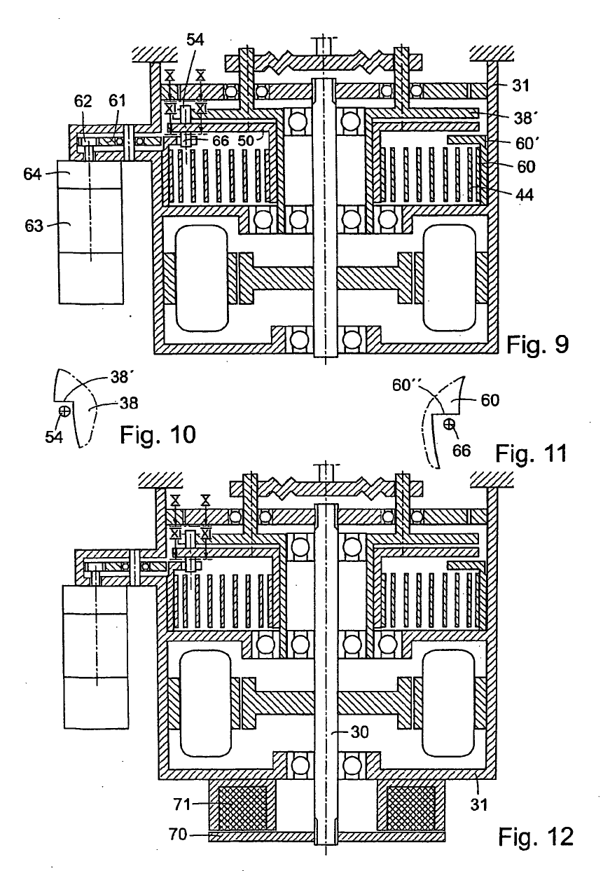

Turning then to the parking brake mechanism, it has similarities with the one in the embodiments of FIGS. 5-8. Again it has a spring sleeve 50 rotatable in the planet holder 38. The spring sleeve 50 has a drive pin 54 for engagement with a drive edge 38′ in the planet holder 38, as is shown in FIG. 10.

However, in this embodiment the outer end of the parking brake spring 44 is not directly attached to the housing 31 but instead to a housing sleeve 60 rotatably arranged in the housing 31.

A circumferential gear ring 60′ on the housing sleeve 60 is in engagement with an intermediate gear 61 rotatably journalled in the housing 31. The intermediate gear 61 is in turn in engagement with an outgoing gear 62 from an electric parking brake motor 63 attached to the housing 31. The parking brake motor 63 (similar to the embodiment of FIG. 5) is provided with a spring-activated electromagnetic locking device 64, where internal springs provide the locking function, which may be released by electromechanical action. This locking device keeps the parking brake applied, when the parking brake motor is de-energized.

The housing sleeve 60 is connected to the spring sleeve 50 in the following manner: the spring sleeve 50 is on its side facing the housing sleeve 60 provided with a transmission pin 66 for engagement with an edge 60″ in the housing sleeve 60 (as most clearly appears from FIG. 11).

The fifth embodiment according to FIG. 9 (and FIGS. 10 and 11) will allow the following function:

The service brake motor 8 can apply and release the service brake.

The parking brake motor 63 can apply a force in the brake application direction via the prestressed spring 44, which is in series with the force transmission chain from the motor 63 (by the provision of the pin 66 and the recess 60″). The spring-activated electromagnetic locking device 64 keeps the parking brake applied when the parking brake motor is de-energized.

A sixth embodiment is shown in FIG. 12. It has the same design as the fifth embodiment according to FIG. 9, with the exception that the service brake operating mechanism is provided with an electromagnetic locking device in the form of a disc 70 on the motor shaft 30 and an electromagnetic coil 71 on the housing 31.

The service brake motor can apply the brake (but also release it). The parking brake motor can apply the brake via the prestressed parking brake spring, which is in series with the transmission chain of the parking brake motor. A spring-activated electromagnetic or mechanical locking device keeps the parking brake applied at de-energized parking brake motor.

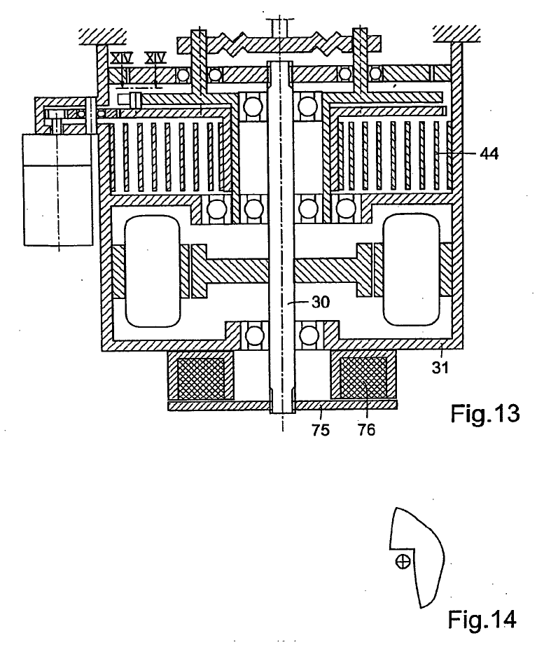

A seventh embodiment shown in FIGS. 13 and 14 has great similarities with the third embodiment shown in FIGS. 5 and 6, and reference is in principle made to these Figures. The principal design difference is the addition of an electromagnetic locking device, comprising (as earlier) a disc 75 on the motor shaft 30 and an electromagnetic coil 76 on the housing 31. Also, the parking brake spring 44 shall be considerably larger than in embodiments one through five.

The service brake motor can apply the brake (but also release it). The prestressed parking brake spring, acting in the brake applying direction, is controlled by the parking brake motor. An electromagnetic locking device prevents the brake from being applied, when the parking brake motor is de-energized. Another electromagnetic locking device will keep the service brake motor in the momentarily attained position.

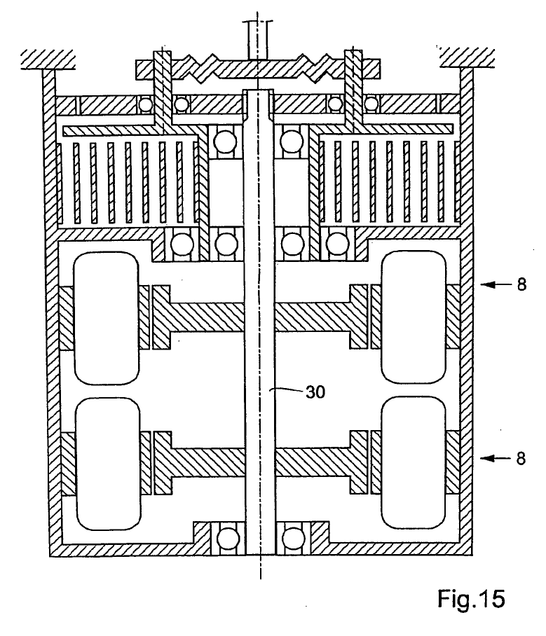

An eighth embodiment is shown in FIG. 15. The embodiment is closely similar to the first embodiment according to FIG. 3, and reference is made to the description thereof. The important difference is that the eighth embodiment in principle has two service brake motors 8 on the same motor shaft 30. The intention with the provision of two service brake motors 8 is to increase the security on the vehicle by having two separate current supplies or two brake circuits for independent current supply of the two motors 8.

Reference is made to the description of FIG. 3 for the function of the brake with its parking brake.

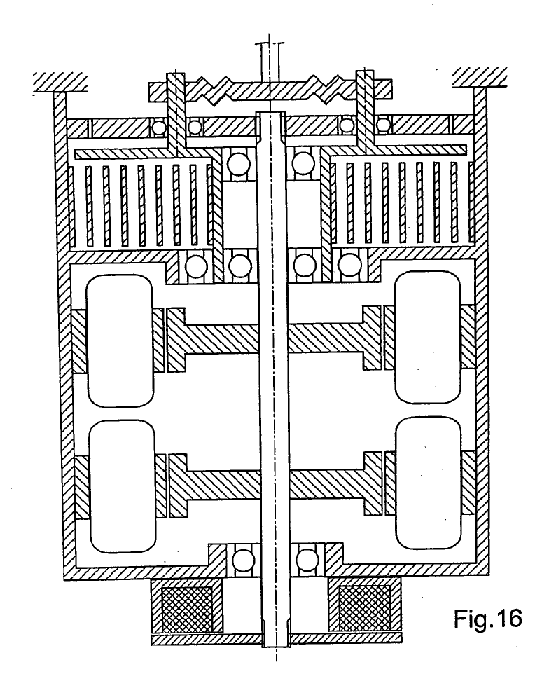

A ninth embodiment of FIG. 16 constitutes the same modification of the eight embodiment of FIG. 15, as the second embodiment of FIG. 4 constitutes of the first embodiment of FIG. 3, namely the addition of an electromagnetic locking device for preventing the application of the brake, when the service brake motor is de-energized.

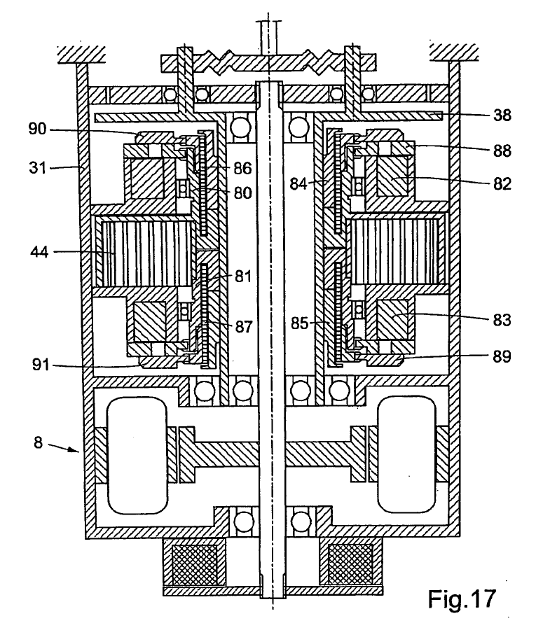

A tenth embodiment is shown in FIG. 17. This embodiment differs from all the other embodiments in that its parking brake spring will be able to provide its force bias not only in the direction for parking brake application but also parking brake release.

The service brake operating mechanism is in principle the same as in previous embodiments, the closest similarity being with the one shown in FIG. 4, to which reference is made. The service brake operating mechanism can be provided with an electromagnetic locking device.

However, the planet holder 38 is here axially extended in order to provide space for the more complicated parking brake mechanism.

The description of this tenth embodiment will be relatively brief but nevertheless provide enough information for the person skilled in the art to carry out the invention (especially after having studied WO 02/49891 containing a detailed description of each of the two main portions of the parking brake mechanism of FIG. 17).

The outer end of a single parking brake spring 44 is attached to a first rotatable base spring sleeve 80 and its inner end to a second rotatable base spring sleeve 81. A first and a second electromagnetic coil device 82 and 83, respectively, are attached in the housing 31 at either side of the spring 44.

A first and a second holder sleeve 84 and 85, respectively, are attached to the planet holder 38.

A first locking spring 86 is arranged between the first base spring sleeve 80 and the first holder sleeve 84 for locking these two members together at relative rotation in one direction but allowing relative rotation in the other direction. Similarly, a second locking spring 87 is arranged between the second base spring sleeve 81 and the second holder sleeve 85.

A first brake disc 88 is axially movably connected to the first base spring sleeve 80 at the first coil device 82, and a second brake disc 89 is acially movably connected to the second base spring sleeve 81 at the second coil device 83.

A first control disc device 90 for engaging the first locking spring 86 is arranged at the first coil device 82 outside the first brake disc 88 and can be attracted to the first coil device 82. Similarly, a second control disc device 91 for engaging the second locking spring 87 is arranged at the second coil device 83 outside the second brake disc 89 and can be attracted to the second coil device 83.

The dimensioning and arrangement of the two locking springs 86 and 87 is such that when one of the two coil devices 82 and 83 is energized, the parking brake spring 44 will bias the planet holder 38 in one direction, and in the other direction at an energizing of the other of the two coil devices 82 and 83.

More specifically, at tightening of the spring 44, one of the coils 82, 83 is de-energized and the other one energized. For holding the parking brake, both coils 82, 83 are energized. For applying the parking brake, one of the coils 82, 83 is de-energized.

The electromagnetic coils 82 and 83, which constitute direct acting brakes or locking devices, may be substituted with indirect acting brakes or locking devices, such as spring actuated devices.

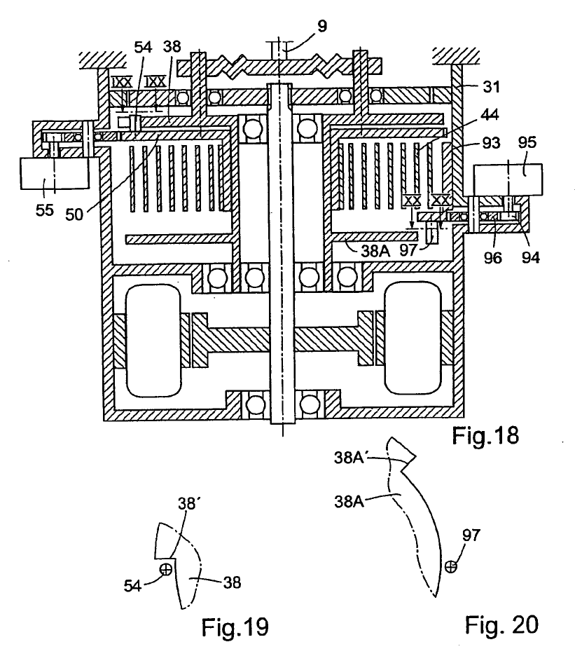

An eleventh embodiment of a parking brake according to the invention is shown in FIGS. 18-20. In its portion to the left in FIG. 18, this embodiment is similar to the one according to FIG. 5. Reference is made to this Figure with its description for details. An exception is that the present embodiment is shown to lack the electric parking brake motor 51 and only has the electromagnetic locking device 55 for the spring sleeve 50, which is provided with a drive pin 54 for engaging the drive edge 38′ in the planet holder 38, as is also shown in FIG. 19. However, an electric parking brake motor together with the electromagnetic locking device 55 can be provided.

In this embodiment the parking brake spring 44 is not attached to the housing 31 but to a housing sleeve 93 rotatably arranged in the housing 31.

The housing sleeve 93 is connected to an outgoing gear 94 on an electromagnetic locking device 95 via an intermediate gear 96 journalled in the housing 31 and in gear engagement with an external gear ring on the housing sleeve 93.

The housing sleeve 93 is provided with a drive pin 97 for engaging a drive edge 38A′ in the circumference of a radial flange 38A of the planet holder 38, as is also depicted in FIG. 20.

Also here the electromagnetic locking device 95 may be combined with an electric parking brake motor.

When released by the electromagnetic locking device 95, the housing sleeve 93 may perform a rotating movement under the action of the parking brake spring 44 and by engaging the planet holder flange 38A with its drive pin 97 rotate the drive shaft 9 in the direction for brake release.

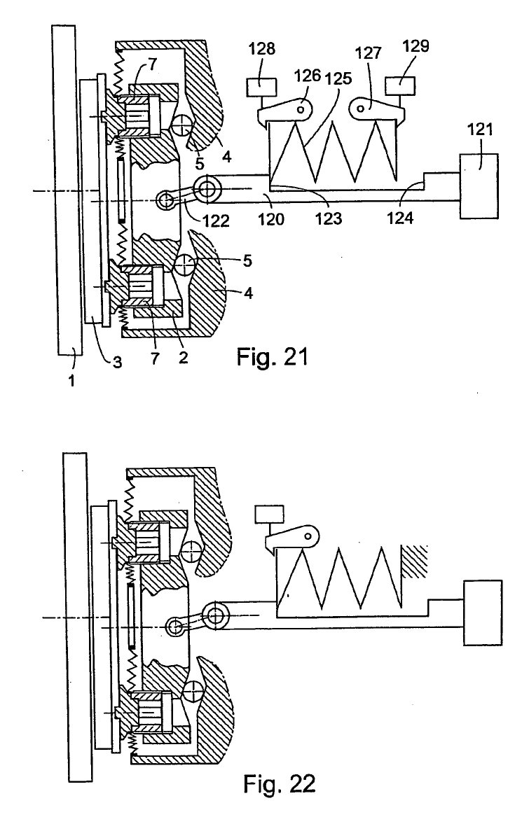

In all the previous embodiments the control force for the service braking has been rotatively applied by an electric motor. Alternatively, the control force can, however, be linearly applied, and FIGS. 21 and 22 are attempts to illustrate the principles of two previously described embodiments of inventive parking brakes used in a linearly applied disc brake.

To the left in FIG. 21 certain basic elements of a self-energizing disc brake, as described above under reference to FIG. 1, may be recognized: the brake disc 1, the ramp plate 2, the brake pad 3, the ramp bridge 4, the rollers 5, and the adjustment screws 7, which in this case, however, are arranged between the ramp plate 2 and the brake pad 3.

An actuator rod 120 is linearly or axially movable under action from a linear actuator 121. The linear control movement of the actuator rod 120 is transmitted to the ramp plate 2 by means of a crank device 122.

The actuator rod 120 is provided with a longitudinal notch having a forward edge 123 (to the left in the drawing) and a rearward edge 124, which at will can be engaged by a parking brake spring or security spring 125, preferably being a helical compression spring.

In the condition shown in FIG. 21, the parking brake spring 125 is held in a compressed state between a forward pawl 126 and a rearward pawl 127 with the forward end of the spring 125 at the forward edge 123 of the actuator rod 120.

Each pawl 126 and 127 can be operated into or out of engagement with the spring 125 by an operating mechanism 128 and 129, respectively, for example an electromagnetic device

In the condition shown in FIG. 21, service braking can be obtained by actuating the linear actuator 121 for linear movement of the actuator rod 120 without any interference from the parking brake spring 125.

Parking braking or security braking is obtained by lifting the forward pawl 126 by means of its operating mechanism 128, so that the parking brake spring 125 in engagement with the forward edge 123 pushes the actuator rod 120 to the left in the drawing.

The spring 125 can later be compressed by the actuator 121 acting to the right in the Figure, and the forward pawl 126 may brought into engagement with the spring 125.

An applied brake may be released in that the rearward pawl 127 is moved out of engagement with the parking brake spring 125, which then—in engagement with the rearward edge 124—will push the actuator rod 120 to the right in the drawing and release the brake.

If the spring 125 is released by both pawls 128 and 129, it will expand against the two actuator rod edges 123 and 124 and have no effect on the actuator rod 120.

FIG. 21 illustrates the function of the parking brake embodiments of FIGS. 17 and 18.

In a similar way, FIG. 22, which is not provided with any reference numerals for the sake of clarity, illustrates the function of the parking brake embodiments of FIGS. 5 and 7. Only a forward pawl with operating mechanism is provided, whereas the rearward end of the parking brake spring is fixed. This means that only the parking brake function can be obtained, not the release function.

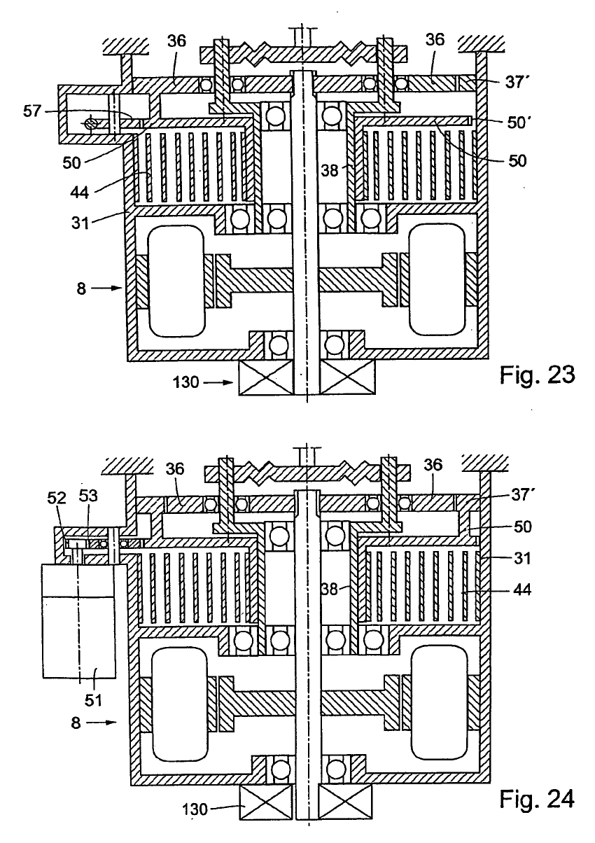

A twelfth and a thirteenth embodiment of an inventive parking brake (with rotative actuation) are shown in FIGS. 23 and 24, respectively. In all previous embodiments, the force from the parking brake spring 44 is transmitted via the planet holder 38, either directly (FIGS. 3, 4, 15-17) or via a spring sleeve 50 (FIGS. 5, 7, 9, 12, 13). In these two last embodiments, the parking brake spring force is transmitted differently, as will appear below. Basically, these two embodiments have similarities with what has been disclosed in WO 03/052286, to which reference is made.

The twelfth embodiment according to FIG. 23 has similarities with the design shown in FIGS. 7 and 8 in that the parking brake spring 44 is attached with its outer end to the housing 31 and with its inner end to the spring sleeve 50. This spring sleeve 50 is provided with circumferential detents 50′, with which an electromagnetically operated pawl 57 (see also FIG. 8) normally is in engagement for rotationally locking the spring sleeve 50 but may be disengaged for applying the parking brake.

In this embodiment, however, the spring sleeve 50 is integrated with the circumferential gear ring 37′ for the planet wheels 36. This gear ring 37′ is, contrary to what is the case in all previous embodiments, rotational in relation to the housing 31. At parking braking a rotational movement in the brake applying direction is transmitted from the gear ring 37′ to the planet wheels 36 and thus the planet holder 38.

Also, the service brake motor 8 has to have a spring-applied electromagnetic locking device 130.

The last embodiment according to FIG. 24 has closest similarities with the one according to FIG. 5. Again, the parking brake spring 44 is attached to the housing 31 and the spring sleeve 50, which may be rotationally operated by an electrical parking brake motor 51 via an outgoing gear 52 and an intermediate gear 53 in engagement with an external gear ring on the spring sleeve 50.

The spring sleeve 50 is integrated with the circumferential gear ring 37′, which is rotational in the housing 31 as in the previous embodiment. At parking braking the planet wheels 36 and thus the planet holder 38 are rotated in the brake applying direction.

As in the embodiment according to FIG. 23, the service brake motor 8 has to have a spring-applied electromagnetic locking device 130.

Generally speaking, all embodiments lend themselves well to realising different safety strategies in connection with fail-safe or fail-tolerant operation of vehicle brakes. Especially it may be noted that the parking brake motors in the embodiments of FIGS. 5, 9, 12, 13, and 24 may be utilized as a second source for service braking, if the normal source fails.

What is claimed is:

1. A method for parking braking at a self-energizing disc brake, having an assembly including a brake pad, movable by service brake actuating means towards and away from a brake disc for service braking, means being provided for enhancing the application of the brake pad against the brake disc after said assembly has been transferred to engagement with the brake disc and under the action of the rotating brake disc, characterized in that a spring force is applied to the assembly for accomplishing parking braking at will.

2. A method according to claim 1, wherein the spring force is generally axially applied.

3. A method according to claim 1, wherein the spring force is generally tangentially applied.

4. A parking brake arrangement for a self-energizing disc brake, having an assembly including a brake pad, movable by service brake actuating means towards and away from a brake disc for service braking, means being provided for enhancing the application of the brake pad against the brake disc after said assembly has been transferred to engagement with the brake disc and under the action of the rotating brake disc, characterized by spring means actuating said assembly for parking braking at will.

5. An arrangement according to claim 4, in which the service brake actuating means is controlled by an electric motor for submitting a rotary motion to an outgoing drive shaft, wherein a clock spring or spiral spring is arranged in the movement transmitting chain between the motor and the shaft and is prestressed in a direction for applying the brake.

6. An arrangement according to claim 5, in which a transmission unit for rotary speed reduction is arranged between the electric motor and the drive shaft, the transmission unit being a planetary gear assembly with a sun wheel driven by the motor, planet wheels in gear engagement with the sun wheel and an outer, circumferential gear ring, with which the planet wheels are in gear engagement, each planet wheel having a central pin for transferring rotary motion to the drive shaft at its rotation around the sun wheel, wherein the clock spring is arranged to act in a brake applying direction on a planet holder, which is rotatably journalled in a housing of the motor and is provided with the pins, on which the planet wheels are journalled.

7. An arrangement according to claim 6, wherein the gear ring is fixed in the housing and the spring is attached to the housing and the planet holder with its two ends.

8. An arrangement according to claim 7, wherein the electric motor is provided with an electromagnetic locking device.

9. An arrangement according to claim 6, wherein the spring is attached to the housing at its outer end and to a spring sleeve at its inner end, the spring sleeve being connectable at will to the planet holder by means of a drive pin engageable with a drive edge of the planet holder for driving the planet holder in a brake applying direction.

10. An arrangement according to claim 9, wherein the spring sleeve is provided with a releasable locking device.

11. An arrangement according to claim 10, wherein the locking device is an electromagnetic locking device acting on the spring sleeve via gears.

12. An arrangement according to claim 11, wherein the locking device is combined with an electric parking brake motor.

13. An arrangement according to claim 10, wherein the locking device is an electromagnetically controlled pawl for cooperation with circumferential detents on the spring sleeve.

14. An arrangement according to claim 6, wherein the gear ring is fixed in the housing and the spring is attached to a housing sleeve and the planet holder with its two ends.

15. An arrangement according to claim 14, wherein the electric motor is provided with an electromagnetic locking device.

16. An arrangement according to claim 14, wherein the spring is attached to the housing sleeve at its outer end and to a spring sleeve at its inner end, the spring sleeve being connectable at will to the planet holder by means of a drive pin engageable with a drive edge of the planet holder for driving the planet holder in a brake applying direction and with the housing sleeve by means of a transmission pin engageable with a drive edge of the planet holder for driving the planet holder in a brake applying direction.

17. An arrangement according to claim 14, wherein the spring is attached to the housing sleeve at its outer end and to a spring sleeve at its inner end, the spring sleeve being connectable at will to the planet holder by means of a drive pin engageable with a drive edge of the planet holder for driving the planet holder in a brake applying direction and the housing sleeve being connectable at will to a planet holder flange by means of a drive pin engageable with a drive edge of the planet holder flange for driving the planet holder in a brake releasing direction.

18. An arrangement according to claim 17, wherein the spring sleeve is provided with a releasable locking device.

19. An arrangement according to claim 18, wherein the locking device is an electromagnetic locking device acting on the spring sleeve via gears.

20. An arrangement according to claim 17, wherein the housing sleeve is provided with a releasable locking device.

21. An arrangement according to claim 20, wherein the locking device is an electromagnetic locking device acting on the spring sleeve via gears.
